(19) United States
(12) Patent Application Publication
(10) Pub. No.: US 2017/0003873 A1
(43) Pub. Date: Jan. 5, 2017

(54) METHOD FOR CONTROLLING MOBILE DEVICE, RECORDING MEDIUM STORING PROGRAM TO IMPLEMENT THE METHOD, DISTRIBUTING SERVER FOR DISTRIBUTING APPLICATION, AND MOBILE DEVICE

(71) Applicant: REALVALUE CO., LTD., Daegu (KR)

(72) Inventors: Kyu Hwan Park, Seoul (KR); Hyo Soo Kim, Daegu (KR); Ji Sun Bai, Seoul (KR)

(73) Assignee: REALVALUE CO., LTD., Daegu (KR)

(21) Appl. No.: 14/901,942

(22) PCT Filed: Jun. 30, 2014
(86) PCT No.: PCT/KR2014/005821

§ 371 Date: Dec. 29, 2015

(30) Foreign Application Priority Data
Jul. 2, 2013 (KR) 10-2013-0077195
Jul. 20, 2013 (KR) 10-2013-0085736
Aug. 12, 2013 (KR) 10-2013-0095630
Mar. 27, 2014 (KR) 10-2014-0036119

(51) Int. Cl. G06F 3/0488; G06F 3/023; G06F 3/01

(52) U.S. Cl. CPC G06F 3/04886; G06F 3/018; G06F 3/0236; G06F 3/0486

(57) ABSTRACT

Provided are a method of controlling a mobile device having an improved user's convenience of inputting, a recording medium storing a program for executing the method, an application distribution server, and a mobile device. The method includes displaying character arrangement window on an edge of a display area, and when a touch has occurred on a portion, on which the character arrangement window is not displayed, in the display area, regarding the touch as an event that a character corresponding to the touch, from among characters included in the character arrangement window, is input.

### TECHNICAL FIELD

The inventive concept relates to a method of controlling a mobile device, a recording medium storing a program for implementing the method, an application distribution server, and a mobile device, and more particularly, to a method of controlling a mobile device having an improved input convenience of a user, a recording medium storing a program for implementing the method, an application distribution server, and a mobile device.

### BACKGROUND ART

Recently, demands for mobile devices such as smart phones, tablet PCs, etc. have rapidly increased. Such mobile devices have an input unit such as a keyboard for executing various functions, and accordingly, volumes of the mobile devices increase. To address the above problem, a touch screen has been adopted in a mobile device, and thus, when a character needs to be input, a user may input a character by touching the character displayed on a touch screen.

### DETAILED DESCRIPTION OF THE INVENTIVE CONCEPT

### Technical Problem

However, according to the conventional mobile device, when characters are displayed on a touch screen, other images than the characters may not be displayed or an area of displaying the other images than the characters is greatly reduced.

The inventive concept provides a method of controlling a mobile device having an improved user's convenience of inputting, a recording medium storing a program for implementing the method, an application distribution server, and a mobile device. However, a scope of the inventive concept is not limited thereto.

### Technical Solution

According to an aspect of the inventive concept, there is provided a method of controlling a mobile device, the method including: displaying a character arrangement window on an edge of a display area; and when a touch has occurred on a region, on which the character arrangement window is not displayed, regarding the touch as an event that a character corresponding to the region where the touch has occurred is input.

The edge may include a first edge, a second edge adjacent to the first edge, a third edge facing the second edge and adjacent to the first edge, and a fourth edge facing the first edge, and the displaying of the character arrangement window comprises displaying the character arrangement window on the first edge to the third edge of the display area.

The displaying of the character arrangement window may include displaying the character arrangement window on the first edge to the fourth edge.

The character arrangement window may not be displayed on a portion, except for the first edge to the fourth edge.

The regarding of the input of the corresponding character may include dividing the display area into a plurality of regions including regions corresponding to characters included in the character arrangement window, and when a touch has occurred on a region in the display area, regarding the touch as an event that a character corresponding to the region where the touch has occurred is input.

The plurality of regions may fill an entire portion of the display area.

The plurality of regions may include a portion on which the character arrangement window is displayed, and a portion adjacent to the portion where the character arrangement window is displayed.

The plurality of regions may fill a remaining portion of the display area, except the portion where the character arrangement window is displayed. Here, the method may further include, when a touch has occurred in at least a part that is set in advance in the portion where the character arrangement window is displayed, regarding the touch as an event that a specific function execution command that is set in advance is input.

The displaying of the character arrangement window may include displaying lines that divide the display area into the plurality of regions or dots corresponding to the plurality of regions on the display area.

According to an aspect of the inventive concept, there is provided a recording medium having embodied thereon a program for executing the above method.

According to an aspect of the inventive concept, there is provided a distribution server for providing a character input application operating in a mobile device through a network, wherein the character input application displays character arrangement window on an edge of a display area; and when a touch has occurred on a region, on which the character arrangement window is not displayed, regards the touch as an event that a character corresponding to the region where the touch has occurred is input.

According to an aspect of the inventive concept, there is provided a mobile device including: a display unit comprising a display area and provided with a touch screen function; and a character determiner configured to determine a character corresponding to a touch according to a location where the touch has occurred, when the touch has occurred in the display area, wherein the display unit displays character arrangement window on an edge of the display area, and when a touch has occurred on a region, on which the character arrangement window is not displayed, the character determiner determines a character corresponding to the region where the touch has occurred is input, from among characters included in the character arrangement window.

The edge may include a first edge, a second edge adjacent to the first edge, a third edge facing the second edge and adjacent to the first edge, and a fourth edge facing the first edge, and the display unit may display the character arrangement window on the first edge to the third edge of the display area.

The display unit may display the character arrangement window on the first edge to the fourth edge.

The display unit may not display the character arrangement window on a portion, except the first edge to the fourth edge.

Here, the character determiner may divide the display area into a plurality of regions corresponding to characters included in the character arrangement window, and when a touch has occurred in the display area, determines a character, from among characters included in the character arrangement window, corresponding to the region where the touch has occurred is input from among the plurality of regions.

The plurality of regions may fill an entire portion of the display area.

The plurality of regions may include a portion on which the character arrangement window is displayed, and a portion adjacent to the portion where the character arrangement window is displayed.

The plurality of regions may fill a remaining portion of the display area, except the portion where the character arrangement window is displayed. In this case, when a touch has occurred in at least a predetermined part of the portion on which the character arrangement window is displayed, the character determiner regards the touch as an event that a specific function execution command that is set in advance is input.

The display unit may display lines that divide the display area into the plurality of regions or dots corresponding to the plurality of regions on the display area.

### Advantageous Effects

According to one or more exemplary embodiments of the inventive concept, a method of controlling a mobile device capable of improving user's convenience in input operation, a recording medium storing a program for executing the method, an application distribution server, and a mobile device may be implemented. However, a scope of the inventive concept is not limited by the effects.

### DESCRIPTION OF THE DRAWINGS

FIG. 1 is a schematic block diagram showing a part of a mobile device according to an exemplary embodiment;

FIG. 2 is a conceptual view of a display unit of FIG. 1;

FIG. 3 is a conceptual view of the display unit of FIG. 1, wherein the display unit displays a character arrangement window;

FIG. 4 is a conceptual view schematically showing character input regions on the display unit of FIG. 1;

FIG. 5 is a conceptual view schematically showing displaying of characters corresponding to a region on the region, when the region on the display unit of FIG. 4 is touched;

FIG. 6 is a conceptual view schematically showing character input regions on a display unit in a mobile device according to another exemplary embodiments;

FIG. 7 is a conceptual view schematically showing a display unit in a mobile device according to another exemplary embodiment;

FIG. 8 is a conceptual view showing character arrangement window displayed on the display unit of FIG. 7;

FIG. 9 is a conceptual view schematically showing character input regions on the display unit of FIG. 8;

FIG. 10 is a conceptual view schematically showing character input regions on a display unit of a mobile device according to another exemplary embodiment;

FIG. 11 is a schematic perspective view of a mobile device according to another exemplary embodiment;

FIG. 12 is a schematic conceptual view of a display unit of a mobile device according to another exemplary embodiment;

FIG. 13 is a schematic conceptual view of a display unit of a mobile device according to another exemplary embodiment; and

FIG. 14 is a schematic conceptual view of a display unit of a mobile device according to another exemplary embodiment.

### BEST MODE

Hereinafter, the inventive concept will be described more fully with reference to the accompanying drawings, in which exemplary embodiments of the inventive concept are shown. This inventive concept may, however, be embodied in many different forms and should not be construed as limited to the exemplary embodiments set forth herein. Rather, these embodiments are provided so that this disclosure will be thorough and complete, and will fully convey the scope of the inventive concept to one of ordinary skill in the art. Sizes of components in the drawings may be exaggerated for convenience of explanation. In other words, since sizes and thicknesses of components in the drawings are arbitrarily illustrated for convenience of explanation, the following embodiments are not limited thereto.

In the following examples, the x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

Hereinafter, a “mobile device” may be any digital device including a memory unit and a microprocessor for performing a computation function such as a smart phone, a smart watch, a tablet PC, a laptop computer, a web pad, etc., provided that the digital device is portable. In some cases, a user terminal that is temporarily portable, e.g., a desk top computer, a workstation, etc., may be regarded as a mobile device according to the inventive concept.

A terminology “character” denotes an item that may be displayed on a display unit in an input mode of letters, etc., in the mobile device, and may include various symbols, as well as Korean letters, alphabets, and numbers.

In addition, a terminology “touch” denotes a user's action of touching a display unit having a touch screen function of the mobile device by his/her finger. “Drag” denotes an operation in which the user moves his/her finger in contact with the display unit of the mobile device. “Drop” denotes an operation in which the user removes his/her finger that has touched, that is, contacted the display unit of the mobile device, from the display unit.

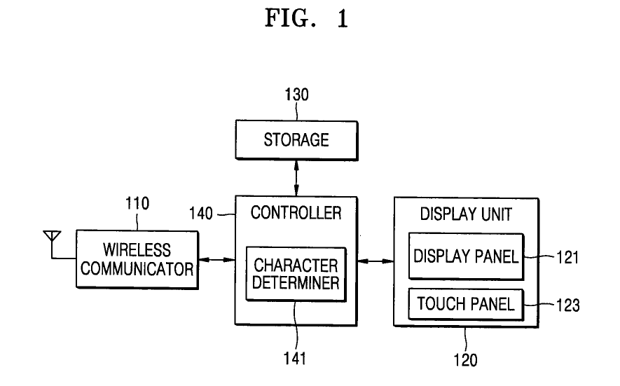

FIG. 1 is a schematic block diagram of a part of a mobile device according to an exemplary embodiment. The mobile device according to the present exemplary embodiment includes a wireless communicator 110, a display unit 120, a storage 130, and a controller 140.

The wireless communicator 110 performs wireless communication function of the mobile device 100. The wireless communicator 110 may include a radio frequency (RF) transmitter for elevating and amplifying a frequency of a transmission signal, and an RF receiver for amplifying noise of a reception signal and descending a frequency of the reception signal. If the mobile device does not have a communication function, the wireless communicator 110 may be omitted.

The display unit 120 includes a display panel 121 and a touch panel 123, if necessary, the display panel 121 and the touch panel 123 may be integrated as a single panel. That is, the display unit 120 has a display area and a touch screen function, at the same time. The display unit may include, for example, an organic light-emitting diode (OLED), a liquid crystal device (LCD), etc.

The storage 130 may include a program memory and data memories. The program memory may store an operating program of the mobile device 100, and a program or an application for inputting characters by using a touch screen function of the display unit 120 that will be described later. The data memories may store data that generates during executing a program.

The controller 140 may control overall operations of the mobile device 100. In addition, the controller 140 may include a data processor including a transmitter for encoding and modulating a transmission signal and a receiver for demodulating and decoding a reception signal. The data processor may include a modem and a codec. The controller 140 receives a touch signal from the display unit 120 to detect a touch, a drag, and a drop operation occurring on the display unit 120. In addition, the controller 140 may include a character determiner 141 that determines a character corresponding to a touched location, when a touch occurs within the display area of the display unit 120. The character determiner 140 may be an additional element of the mobile device, not a part of the controller 140 as shown in FIG. 1.

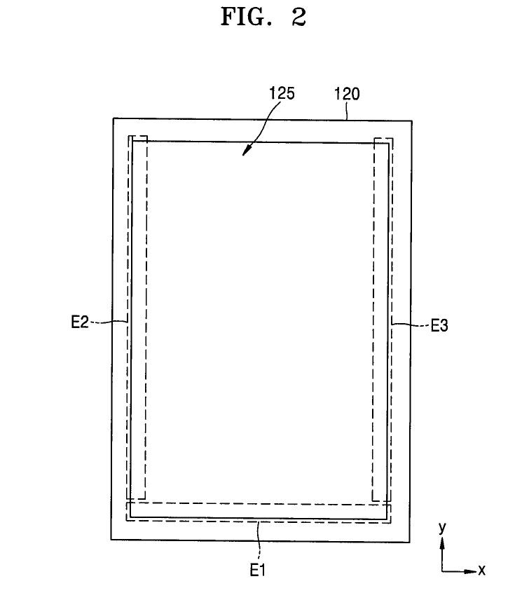

The display unit 120 of the mobile device according to the present exemplary embodiment may include a display area 125 as shown in FIG. 2. The display area 125 has, as shown in FIG. 2, a first edge E1 located in a −y direction and extending along an x axis, a second edge E2 adjacent to the first edge E1, and located in a −x direction and extending along a y axis, a third edge E3 facing the second edge E2 about a center portion of the display area 125, wherein the third edge E3 is adjacent to the first edge E1 and located in a +x direction to extend along the y axis, and a fourth edge facing the first edge E1 about the center portion of the display area 125, wherein the fourth edge is located in +y direction to extend along the x axis.

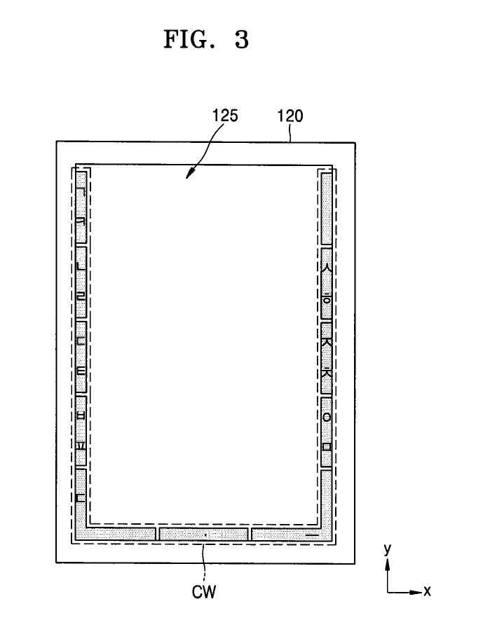

The display unit 120 may display a character arrangement window CW on the display area 125 as shown in FIG. 3. In more detail, the display unit 120 may display the character arrangement window CW on the first edge E1, the second edge E2, and the third edge E3. That is, it may be appreciated that the mobile device according to the present exemplary embodiment may display the character arrangement window CW on a part of the edge of the display area 125 of the display unit 120. That is, as shown in FIG. 3, the character arrangement window CW is only displayed on the first edge E1, the second edge E2, and the third edge E3. That is, the display unit 120 may not display the character arrangement window CW on the other portions in the display area 125 than the first edge E1 to the fourth edge.

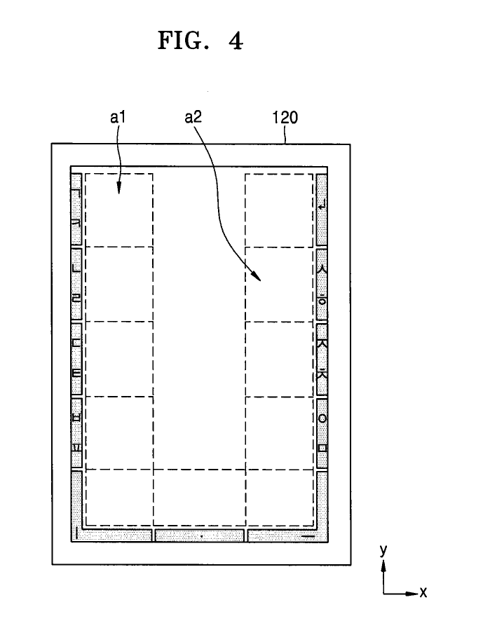

In the mobile device according to the present exemplary embodiment, a portion that the user has to touch in order to input characters is not limited to the character arrangement window CW shown in FIG. 3 themselves. The portion that the user has to touch in order to input the characters may include an entire area of the display area 125, or at least a part of the display area 125, that is, at least a part of the other portion than the portions where the character arrangement window CW is displayed. For example, as shown in FIG. 4, the portion may include an area that is set in advance toward the center portion of the display area 125 along the first to third edges E1 to E3 (inside an area denoted by dotted lines). Therefore, when a touch occurs in the above portion, the character determiner 141 determines a character from among the characters included in the character arrangement window CW displayed on the first, second, and third edges E1, E2, and E3, and the mobile device recognizes that the corresponding character has been input.

For example, the character determiner 141 divides the display area 125 into a plurality of regions corresponding to the characters included in the character arrangement window CW, and when a touch has occurred in the display area 125, the character determiner 141 may determine a character from among the characters included in the character arrangement window CW, wherein the determined character corresponds to the region, in which the touch has occurred, from among the plurality of regions.

In more detail, as shown in FIG. 4, when the user touches a point a1 adjacent to the second edge E2, not the second edge E2 itself, in the display area 125, the character determiner 141 determines “ [symbol] ” corresponding to the point a1, from among the characters displayed on the second edge E2, and the mobile device recognizes that the character “ [symbol] ” is input. If the user touches the point a1 twice successively, the character determiner 141 determines a character “ [symbol] ” corresponding to the point a1, from among the characters displayed on the second edge E2, and the mobile device recognizes that the character “ [symbol] ” is input. As shown in FIG. 4, if the user touches a point a2, not the third edge E3 itself, the character determiner 141 determines a character “ [symbol] ” corresponding to the point a2, from among the characters displayed on the third edge E3, the mobile device recognizes that the character “ [symbol] ” is input.

In the mobile device according to the present exemplary embodiment, the display unit 120 does not display the character arrangement window CW on the other portions of the display area 125 than the first edge E1, the second edge E2, the third edge E3, and the fourth edge. Therefore, even in a character input mode, other application images may be continuously displayed on a large area of the display area 125, except the first edge E1 to the fourth edge, and thus, a visibility of the user may be improved greatly. In particular, in the case of FIG. 3, in the character input mode, the application images may be continuously displayed on a large area of the display area 125, except the first edge E1 to the third edge E3.

In addition, according to the mobile device according to the present exemplary embodiment, when the user inputs a character by using a touch screen function, the user does not need to touch a narrow portion, that is, in the character arrangement window CW displayed on the first edge E1, the second edge E2, and the third edge E3, but the user may touch the large area corresponding to the character arrangement window in the display area 125. Therefore, a mis-touch or mis-input of the user who inputs the characters may be prevented effectively, and moreover, the user may rapidly input the characters.

In FIG. 4, the character arrangement window CW includes Korean characters such as [symbol] , [symbol] , [symbol] , [symbol] , etc., but one or more exemplary embodiments are not limited thereto. For example, the character arrangement window CW may include numbers or various symbols, as well as characters of various languages, such as English, Japanese, Chinese, etc.

In addition, the display unit 120 may display characters on a plurality of regions, including the point a1 and the point a2, that is, on the other portions than the first edge E1, the second edge E2, and the third edge E3, in the display area 125. In this case, the display unit 120 may display the characters in a semi-transparent state so that the user visually recognize the characters, and at the same time, in the character input mode, the other application images may be continuously displayed on the large area within the display area 125, except the first edge E1 to the third edge E3.

If necessary, as shown in FIG. 4, the display unit 120 may display lines that divide the display area 125 into the plurality of regions. As such, the user may visually recognize the plurality of regions corresponding to the characters, in the display area 125, and at the same time, in the character input mode, the other application images may be continuously displayed on the large area of the display area 125, except the first edge E1 to the third edge E3. Unlike in FIG. 4, various modifications may be adopted, for example, the display unit 120 may display dots corresponding to the plurality of regions, not the lines dividing the display area 125 into the plurality of regions.

In addition, in the character input mode, when a touch has occurred within at least a predetermined part of the portion displaying the character arrangement window CW, the character determiner 141 may regard such touch as an event that a specific function execution command that is set in advance is input. For example, in the case illustrated in FIG. 4, when a periphery of a center in the first edge E1 is touched, the character determiner 141 may regard such touch as an event that a space corresponding to a space bar has been input. Here, the specific function execution command that is set in advance may be changed through a setting change in the mobile device. Otherwise, in the character input mode, when a touch input occurs within at least a predetermined portion in the portions where the character arrangement window CW is displayed in a state where some characters are input, a recommended word is displayed on the display unit 120 based on the some characters that have been input so that the user may select the recommended word.

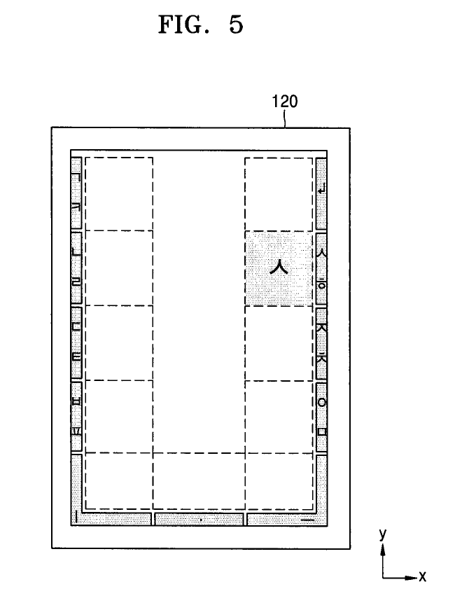

When the user touches one of the plurality of regions in the character input mode, it may be difficult for the user to recognize instantly which character has been selected. Therefore, as shown in FIG. 5, from among the plurality of regions, the selected character (e.g., “ [symbol] ”) may be temporarily displayed on the region that the user has touched. If necessary, the selected character (e.g., “ [symbol] ”) may be temporarily displayed on another predetermined portion (e.g., an upper right corner or a center portion of the display area 125), not the region that the user has touched.

### Mode of the Inventive Concept

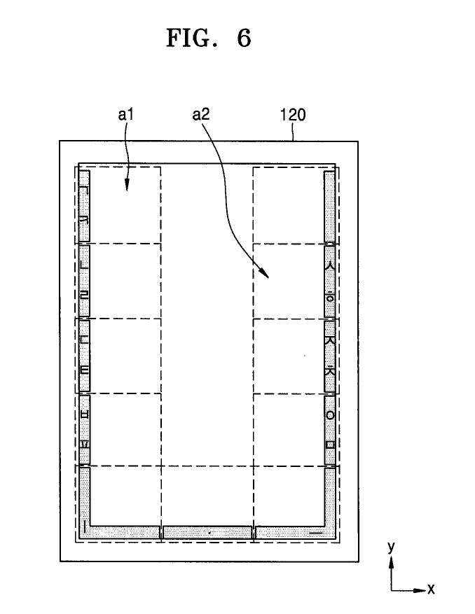

FIG. 6 is a schematic conceptual view showing character input regions in the display unit 120 of the mobile device according to the exemplary embodiment. In the mobile device according to the present exemplary embodiment, when the display area 125 is divided into the plurality of regions corresponding to the characters included in the character arrangement window CW, the plurality of regions include a portion on which the character arrangement window CW is displayed and an adjacent portion. That is, the first to third edges E1 to E3 may be included in the plurality of regions. As such, each of the plurality of regions may be ensured as large as possible in size without increasing the display area 125, so that user's convenience of inputting the characters may be improved.

In detail, as shown in FIG. 6, the point a1 in the display area 125 may include a part of the second edge E2 and adjacent portion, and accordingly, when the user touches the point a1, the character determiner 141 determines a character “ [symbol] ” included in the second edge E2 corresponding to the point a1 so that the mobile device recognizes that the character “ [symbol] ” is input. Here, an area of the point a1 is greater than that of the point a1 shown in FIG. 4, the user may input characters more conveniently. Likewise, the point a2 may include a part of the third edge E3 and an adjacent portion. Accordingly, when the user touches the point a2, the character determiner 141 determines a character “ [symbol] ” included in the third edge E3 corresponding to the point a2, and thus, the mobile device recognizes that the character “ [symbol] ” is input.

In addition, the display unit 120 may display characters on the plurality of regions including the point a1, the point a2, etc., that is, the other portions than the first edge E1, the second edge E2, and the third edge E3 in the display area 125. In this case, the corresponding characters may be displayed in a semi-transparent state so that the user may recognize the characters visually. Meanwhile, in the character input mode, other application images may be continuously displayed on a large area in the display area 125, except the first edge E1 to the third edge E3.

If necessary, as shown in FIG. 6, the display unit 120 may display lines that divide the display area 125 into the plurality of regions. As such, the user may visually recognize the plurality of regions of the display area 125, which correspond to the characters, and at the same time, the other application images may be continuously displayed on the large area in the display area 125, except the first edge E1 to the third edge E3, in the character input mode. Unlike the exemplary embodiment of FIG. 6, the display unit 120 may display dots corresponding to the plurality of regions, not the lines dividing the display area 125 into the plurality of regions.

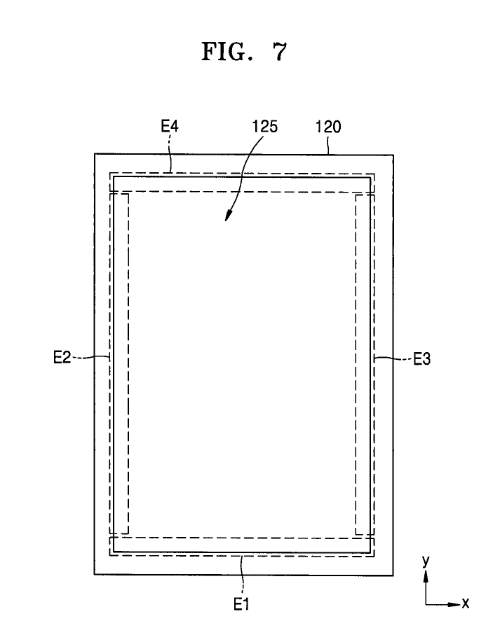

FIG. 7 is a schematic conceptual view showing the display unit of the mobile device according to another exemplary embodiment. The display area 125 of the display unit 120 in the mobile device includes the first edge E1 to the fourth edge E4 as shown in FIG. 7.

As shown in FIG. 7, the display unit 120 may display character arrangement window CW on the display area 125. In more detail, the display unit 120 may display the character arrangement window CW on the first edge E1 to the fourth edge E4 of the display area 125. Consequently, the mobile device according to the present exemplary embodiment may display the character arrangement window CW on an edge of the display area 125. Here, the display unit 120 does not display the character arrangement window CW on the other portions than the first edge E1 to the fourth edge E4 in the display area 125.

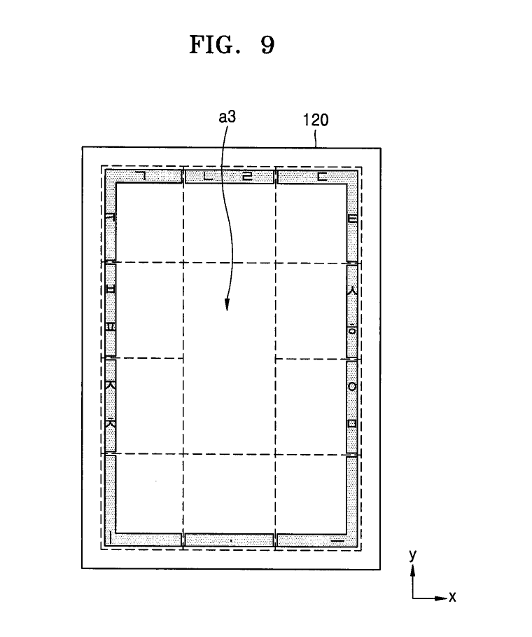

In the mobile device according to the present exemplary embodiment, the portion that the user has to touch in order to input characters is shown in FIG. 9. That is, the portion is predetermined area toward the center portion of the display area 125 along the first edge E1 to the fourth edge E4 (inside the region denoted by dotted lines). That is, the portion may have greater area than the character arrangement window CW along the edge of the display area 125. Therefore, when the touch occurs on the above portion, the character determiner 141 determines a character from among the characters included in the character arrangement window CW displayed on the first edge E1 to the fourth edge E4, and recognizes that the determined character is input.

For example, the display area 125 is divided into the plurality of regions corresponding to the characters included in the character arrangement window CW, and when a touch has occurred in the display area 125, the character determiner 141 may determine a character corresponding to the region, in which the touch has occurred, from among the plurality of regions.

In the above mobile device according to the present exemplary embodiment, the display unit 120 does not display the character arrangement window CW on the other portions in the display area 125 than the first edge E1 to the fourth edge E4. Therefore, in the character input mode, the other application images may be continuously displayed on the large area of the display area 125, except the first edge E1 to the fourth edge E4, and thus, user's visibility may be improved greatly.

In addition, in the mobile device of the present exemplary embodiment, when the user inputs characters by using the touch screen function, the user may touch the large area portions corresponding to the character arrangement window CW in the display area 125, not the narrow area portions in the character arrangement window CW. Therefore, mis-touch or mis-input during the input operation of the user may be prevented, and thus, the user may rapidly input the characters.

In addition, the display unit 120 may display characters on the other portions than the first edge E1 to the fourth edge E4 in the display area 125, that is, the plurality of regions. In this case, the characters may be displayed in the semi-transparent state so that the user may visibly recognize the characters, and at the same time, in the character input mode, the other application images may be continuously displayed on the large area portions in the display area 125 except the first edge E1 to the fourth edge E4.

As shown in FIG. 9, if necessary, the display unit 120 may display lines that divide the display area 125 into the plurality of regions. Otherwise, dots corresponding respectively to the plurality of regions may be displayed.

In addition, in the character input mode, when a touch has occurred in at least a part of the predetermined portion from among the portions displaying the character arrangement window CW, the character determiner 141 may regard such touch as an event that a specific function execution command that is set in advance is input. Otherwise, as shown in FIG. 9, since a center portion a3 of the display area 125 does not correspond to characters included in the character arrangement window CW, when a touch has occurred on the center portion a3, the character determiner 141 may regard such touch as an event that the specific function execution command that is set in advance is input.

The specific function execution command may include a space input or a recommended word display based on characters that are partially input. Otherwise, the specific function may be a general multi-tasking function, and in this case, a plurality of applications may be executed on one screen or a plurality of applications may be executed in a single character arrangement window CW.

In addition, in the character input mode, a swiping input may be performed. Here, during the swiping, the center portion a3 may be utilized. For example, the user may touch and drag a region corresponding to a character “ [symbol] ”, from among the plurality of regions shown in FIG. 9, toward the center portion a3 of the display area, to a region corresponding to a character “ [symbol] ” and to the center portion a3 again, to a region corresponding to a character “ ” and to the center portion a3 again, and then, to a region corresponding to a character “ [symbol] ” and drop his/her finger. In this case, the mobile device recognizes that a letter “ [symbol] ” is input. The center portion a3 of the display area 125 is used during swiping, the character input may be accurately performed through the swiping action.

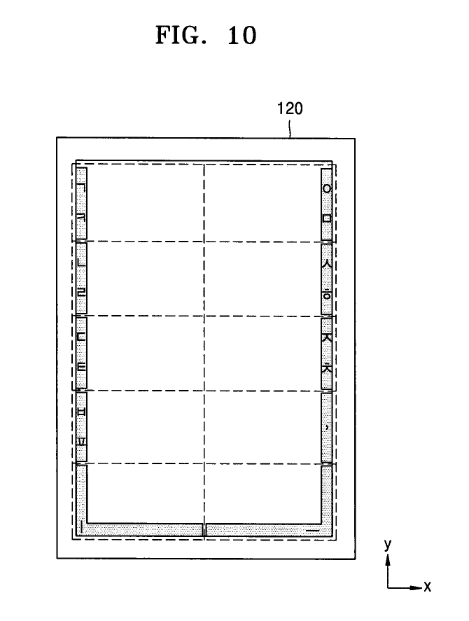

FIG. 10 is a conceptual view schematically showing character input regions on the display unit 120 of the mobile device according to another exemplary embodiment. According to the mobile device of the present exemplary embodiment, when the display area 125 is divided into a plurality of regions corresponding characters included in the character arrangement window CW, the plurality of regions may fill the entire display area 125. As such, an area of each of the plurality of regions may be ensured to the maximum, and thus, a user's convenience in touching may be improved. If necessary, the plurality of regions may fill the other portion than the first edge E1 to the third edge E3, or may fill the other portion than the first edge E1 to the fourth edge E4.

In addition, in the mobile device according to the exemplary embodiment, when a certain region that is set in advance in the display area 125 of the display unit 120 is touched, it may be recognized that the touch input is to touch an application displayed on the display area 125, not to input characters, even when a point in the display area 125 is touched. That is, when a certain region that is set in advance in the display area 125 of the display unit 120 is touched, the character input mode may be terminated or paused. However, the above termination or pause of the character input mode may be performed through recognizing a gesture that is set in advance by using a camera module included in the mobile device or through a touch and drag operation of a predetermined pattern on the display area 125.

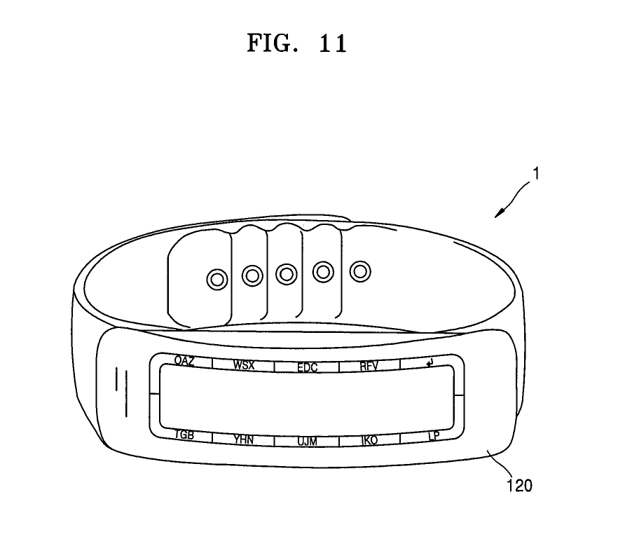

FIG. 11 is a schematic perspective view of a mobile device according to an exemplary embodiment. In more detail, FIG. 11 shows a smart watch. The smart watch has a narrow display area because a user wears the smart watch on his/her wrist. Therefore, when a keyboard for inputting characters is input on the display area of the narrow area, other application images than the keyboard may be invisible.

However, according to the mobile device of the present exemplary embodiment, even when the mobile device such as the smart watch has a narrow display area, the character arrangement window may be only arranged on a narrow area along an edge of the display area as shown in FIG. 11, and the other application images may be continuously on remaining area of the display area. Moreover, a portion the user has to touch in order to input characters is not limited to the narrow area on which the character arrangement window is arranged, but may extend to the large area on which the other application images are being displayed, and accordingly, user's convenience in inputting characters may be improved greatly.

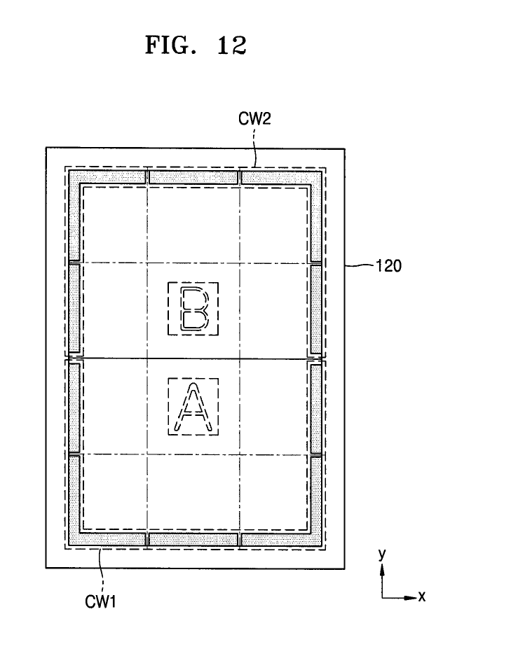

FIG. 12 is a conceptual view schematically showing a display unit 120 of a mobile device according to another exemplary embodiment. As shown in FIG. 12, the display area 125 of the display unit 120 is divided into a plurality of regions, and character arrangement windows CW1 and CW2 may be displayed on at least a part of an edge in each of the plurality of regions. For example, the character arrangement window CW1 including Korean characters may be displayed on a lower region A, and the character arrangement window CW2 including alphabets may be displayed on an upper region B.

One of the character arrangement windows CW1 and CW2 may not include letters, but may include function keys related to an application that is currently operating. For example, if a video is currently displayed, the character arrangement window CW1 or CW2 may include function keys for controlling display of the video. Applications displayed on the lower and upper regions A and B may be different from each other.

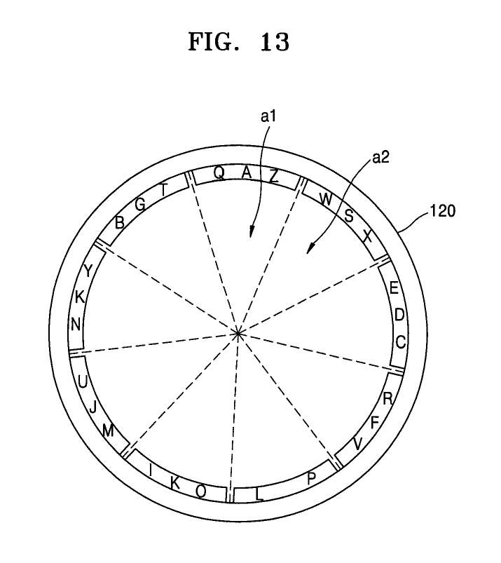

FIG. 13 is a conceptual view schematically showing a display unit 120 of a mobile device according to another exemplary embodiment. As shown in FIG. 13, the display area 120 may have a circular shape or an oval shape, not a square shape. In this case, the character arrangement window CW may be displayed along an edge of the display area. In a state where the character arrangement window CW is displayed as above, when a touch on a portion where the character arrangement window CW is not displayed (e.g., a region a1 or a region a2) has occurred, it may be considered that a character corresponding to the touched portion, from among the characters included in the character arrangement window CW, is input.

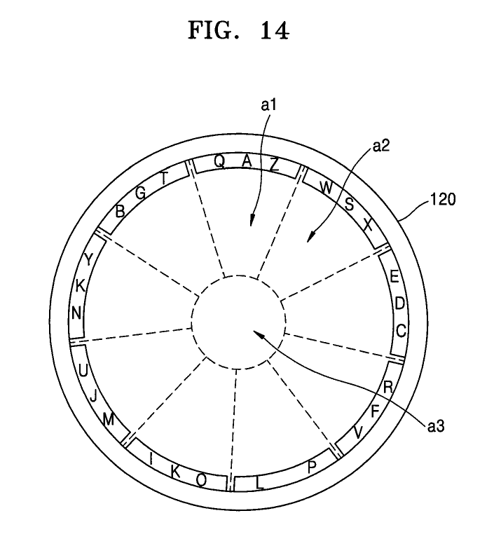

FIG. 14 is a conceptual view schematically showing a display unit of a mobile device according to another exemplary embodiment. The mobile device according to the present exemplary embodiment is different from the mobile device illustrated with reference to FIG. 13 in that a center portion a3 of the display area does not correspond to characters included in the character arrangement window CW. Therefore, when a touch has occurred on the center portion a3, the character determiner 141 may consider as if a specific function execution command that is set in advance is input.

The specific function execution command may include, for example, a space input or a recommended word display based on partial characters that are input. Otherwise, the specific function may be a general multi-tasking function, and in this case, a plurality of applications may be executed on one screen or a plurality of applications may be executed on a single character arrangement window CW.

So far, the mobile device is described, but one or more exemplary embodiments are not limited thereto. For example, a method of controlling a mobile device may be included in a scope of the inventive concept.

The method of controlling the mobile device according to an exemplary embodiment may include displaying the character arrangement window CW on the first edge E1 to the third edge E3 of the display area 125, as shown in FIG. 3. In this case, other application images may be continuously displayed on a portion, except the portion where the character arrangement window CW is displayed, in the display area 125. In addition, when a touch has occurred on the plurality of regions in the display area 125 as shown in FIG. 4, it is considered that a character corresponding to the touched portion is input, from among the characters included in the character arrangement window CW.

In the displaying of the character arrangement window CW, the character arrangement window CW may not be displayed on the other portion than the first edge E1 to the fourth edge E4. In FIG. 3, an example in which the character arrangement window CW is not displayed on the other portion than the first edge E1 to the third edge E3 is shown.

The operation of regarding that the character is input may include dividing the display area 125 into the plurality of regions corresponding to the characters included in the character arrangement window CW, and when a touch has occurred in the display area 125, regarding that the character corresponding to a touched region from among the plurality of regions, from among the characters included in the character arrangement window CW, is input.

In particular, as shown in FIG. 4, a portion having an area predetermined toward the center portion of the display area 125 along the first edge E1 to the third edge E3, e.g., inside of the regions denoted by dotted lines) may be divided into the plurality of regions. Thus, when the touch has occurred on the above portion, the character determiner 141 determines a character, from among the characters included in the character arrangement window CW displayed on the first to third edges E1 to E3, corresponding to the touched portion, and the mobile device considers that the determined character is input.

In the method of controlling the mobile device according to the present exemplary embodiment, the display unit 120 does not display the character arrangement window CW on the other portion than the first edge E1 to the third edge E3. Therefore, even in the character input mode, other application images may be continuously displayed on a large area except the first edge E1 to the third edge E3 in the display area 125, and thus, visibility of the user may be improved greatly.

In addition, according to the method of controlling the mobile device of the present exemplary embodiment, when the user inputs characters via the touch screen function, the user does not need to touch the narrow portion in the character arrangement window CW displayed on the first edge E1 to the third edge E3, but may touch the plurality of regions on the large area. Therefore, mis-touch or mis-input may be effectively prevented when the user inputs characters, and at the same time, the user may rapidly input characters.

The characters included in the character arrangement window CW may include numbers or various symbols, as well as letters of various languages, e.g., English, Japanese, Chinese, etc.

In addition, the displaying of the character arrangement window CW, may include displaying characters corresponding to the plurality of regions, that is, the other portions than the first edge E1 to the third edge E3. In this case, the characters may be displayed in semi-transparent states so that the user may visibly recognize the characters, and at the same time, the other application images may be continuously displayed on the large area except the first edge E1 to the third edge E3 in the display area 125 during the character input mode.

According to the method of controlling the mobile device according to another exemplary embodiment, the displaying of the character arrangement window CW may include displaying lines that divide the display area 125 into the plurality of regions as shown in FIG. 4. As such, the user may visibly recognize the plurality of regions corresponding to the characters, and at the same time, in the character input mode, the other application images may be continuously displayed on the large area of the display area 125, except the first edge E1 to the third edge E3. Unlike the example shown in FIG. 4, dots corresponding respectively to the plurality of regions may be displayed.

In addition, the considering of the character input may not only consider that the characters are input, but also consider that a specific function execution command that is set in advance is input. That is, the specific function execution command that is set in advance may be considered as a kind of character. For example, in the character input mode, when a touch has occurred in at least a predetermined part in the character arrangement window CW, the touch may be regarded as an event that a space corresponding to a space bar is input. Here, the specific function execution command that is set in advance may be changed through a setting of the mobile device. Otherwise, in the character input mode, when a touch has occurred in at least a predetermined part in the character arrangement window CW in a state where some of the characters have been input, a recommended word based on the characters that are already input may be displayed on the display unit 120 so that the user may select the recommended word.

The method of controlling the mobile device may further include temporarily displaying a selected character on a region touched by the user, from among the plurality of regions in the display area 125, as shown in FIG. 5. If necessary, the selected character may be temporarily displayed on a predetermined portion (e.g., an upper right corner or an upper right center of the display area 125), not on the region touched by the user. As such, the user may rapidly and clearly recognize which character has been selected.

According to the method of controlling the mobile device according to another exemplary embodiment, character input regions in the display unit 120 may be increased as shown in FIG. 6. That is, according to the method of controlling the mobile device of the present exemplary embodiment, when the display area 125 is divided into the plurality of regions corresponding to the characters included in the character arrangement window CW, the plurality of regions may include the portions where the character arrangement window CW is displayed and adjacent regions. That is, the first edge E1 to the third edge E3 may be included in the plurality of regions. As such, an area of each of the plurality of regions may be ensured to the maximum while maintaining the area of the display area 125, and thus, convenience of user inputting the characters may be improved.

In addition, the displaying of the character arrangement window CW may include displaying characters on the portion except the first edge E1 to the third edge E3, that is, on the plurality of regions. In this case, the characters may be displayed in a semi-transparent state so that the user may visibly recognize the characters, and at the same time, the other application images may be continuously displayed on the large area of the display area 125, except the first edge E1 to the third edge E3, even in the character input mode.

In the method of controlling the mobile device according to another exemplary embodiment, the displaying of the character arrangement window CW may include displaying the lines dividing the display area 125 into the plurality of regions as shown in FIG. 6. As such, the user may visibly recognize the plurality of regions corresponding to the characters, and at the same time, the other application images may be continuously displayed on the large area of the display area 125, except the first edge E1 to the third edge E3, even in the character input mode. One or more exemplary embodiments may be modified variously unlike the example shown in FIG. 6, for example, the dots corresponding to the plurality of regions respectively may be displayed, not the lines dividing the display area 125 into the plurality of regions.

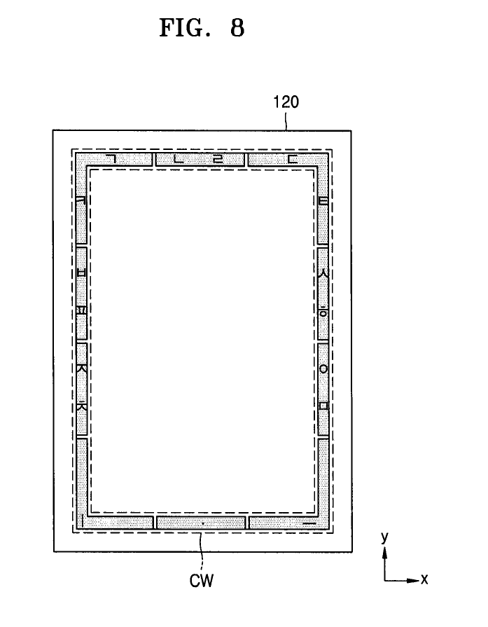

According to the method of controlling the mobile device according to another exemplary embodiment, the displaying of the character arrangement window CW may include displaying the character arrangement window CW on the fourth edge E4, in addition to the first edge E1 to the third edge E3, as shown in FIG. 8. Here, the character arrangement window CW is not displayed on the other portions than the first edge E1 to the fourth edge E4 in the display area 125.

In the method of controlling the mobile device according to the present exemplary embodiment, it may be considered that the character is input when a touch has occurred in a portion (inside the region denoted by the dotted lines) that is set in advance toward the center portion of the display area 125 along the first edge E1 to the fourth edge E4, as shown in FIG. 9. That is, when the user touches a portion along the edge of the display area 125, wherein the portion has a greater area than that of the character arrangement window CW, such touch may be regarded as an event that a character corresponding to the touched portion is input from among the characters included in the character arrangement window CW displayed on the first edge E1 to the fourth edge E4.

According to the method of controlling the mobile device according to the present exemplary embodiment, the display unit 120 does not display the character arrangement window CW on the remaining portion of the display area 125, except the first edge E1 to the fourth edge E4. Therefore, even in the character input mode, the other application images may be displayed continuously on the large area of the display area 125, except the first edge E1 to the fourth edge E4, and thus, the visibility of the user may be improved greatly.

In addition, according to the method of controlling the mobile device of the present exemplary embodiment, when the user inputs characters via the touch screen function, the user may not need to touch the narrow portion in the character arrangement window CW that are displayed on the first edge E1 to the fourth edge E4, but may touch the large area corresponding to the character arrangement window CW in the display area 125. Therefore, when the user inputs the characters, mis-touch or mis-input may be prevented effectively, and the user may rapidly inputs the characters.

In addition, the displaying of the character arrangement window CW may include displaying the characters on the plurality of regions in the display area 125, that is, the other portions than the first edge E1 to the fourth edge E4 in the display area 125. In this case, the characters may be displayed in the semi-transparent state so that the user may visibly recognize the characters, and at the same time, the other application images may be continuously displayed on the large area of the display area 125, except the first edge E1 to the fourth edge E4, even in the character input mode.

If necessary, the displaying of the character arrangement window CW may include displaying the lines dividing the display area 125 into the plurality of regions, as shown in FIG. 9. Otherwise, the dots corresponding respectively to the plurality of regions may be displayed.

In addition, when a touch has occurred on at least a predetermined part of the portion where the character arrangement window CW is displayed in the character input mode, the character determiner 141 may determine that a specific function execution command that is set in advance is input. Otherwise, as shown in FIG. 9, since the center portion a3 of the display area 125 does not correspond to the characters included in the character arrangement window CW, when the user touches the center portion a3, the character determiner 141 may determine that the specific function execution command that is set in advance is input. The specific function may include inputting of a space or displaying of a recommended word based on the partially input characters.

In addition, in the character input mode, a swiping input may be performed. Here, the center portion a3 may be utilized during the swiping operation. For example, the user may touch a region corresponding to a character “ [symbol] ”, from among the plurality of regions as shown in FIG. 9, and drag his/her finger to the center portion a3 in the display area 125 in contact with the screen, to a region corresponding to a character “ [symbol] ” and to the center portion a3, to a region corresponding to a character “.” and to the center portion a3 again, and then, to the region corresponding to the character “ [symbol] ” and drop his/her finger from the screen. In this case, the mobile device recognizes that a letter “ [symbol] ” is input. As such, when the center portion a3 of the display area 125 is used during the swiping operation, the characters may be input precisely through the swiping operation.

In a method of controlling the mobile device according to another exemplary embodiment, when the display area 125 is divided into the plurality of regions corresponding to the characters included in the character arrangement window CW, the plurality of regions may fill the entire display area 125 as shown in FIG. 10. As such, the plurality of regions may each occupy a maximum area, and thus, user's convenience when performing the touch operation to input characters may be improved. If necessary, the plurality of regions may fill the region of the display area 125 except the first to third edges E1 to E3, or may fill the region of the display area 125 except the first to fourth edges E1 to E4.

In addition, according to the method of controlling the mobile device of the one or more exemplary embodiments, once a certain region in the display area 125, which is set in advance, is touched, after that, even when a point in the plurality of regions is touched, it may be considered that the touch input is made to touch another application displayed on the plurality of regions, not to input the characters. That is, when a certain region that is set in advance in the display area 125 of the display unit 120 is touched, the character input mode may be terminated or paused. However, the above termination or pause of the character input mode may be performed through recognizing a gesture that is set in advance by using a camera module included in the mobile device or through a touch and drag operation of a predetermined pattern on the display area 125.

According to the method of controlling the mobile device according to another exemplary embodiment, the displaying of the character arrangement window may include dividing the display area 125 of the display unit 120 into the plurality of regions, and displaying the character arrangement windows CW1 and CW2 on at least a part of an edge in each of the plurality of regions, as shown in FIG. 12. For example, the character arrangement window CW1 including Korean characters may be displayed on a lower region A, and the character arrangement window CW2 including alphabets may be displayed on an upper region B.

One of the character arrangement windows CW1 and CW2 may not include letters, but may include function keys related to an application that is currently operating. For example, if a video is currently displayed, the character arrangement window CW1 or CW2 may include function keys for controlling display of the video. Applications displayed on the lower and upper regions A and B may be different from each other.

According to the method of controlling the mobile device of another exemplary embodiment, as shown in FIG. 13, the display area 120 may have a circular shape or an oval shape, not a square shape, and the displaying of the character arrangement window may include displaying the character arrangement window CW along the edge of the display area. In this case, in a state where the character arrangement window CW is displayed as above, when a touch on a portion where the character arrangement window CW is not displayed (e.g., a region a1 or a region a2) has occurred, such touch may be regarded as an event that a character corresponding to the touched portion, from among the characters included in the character arrangement window CW, is input.

According to the method of controlling the mobile device, as shown in FIG. 14, the center portion a3 of the display area may not correspond to the characters included in the character arrangement window CW. According to the method of the present exemplary embodiment, when a touch has occurred on the center portion a3, the character determiner 141 may consider that a specific function execution command that is set in advance is input.

The specific function execution command may include, for example, a space input or a recommended word display based on partial characters that are input. Otherwise, the specific function may be a general multi-tasking function, and in this case, a plurality of applications may be executed on one screen or a plurality of applications may be executed on a single character arrangement window CW.

A program for executing the controlling method according to the above-described exemplary embodiments and modified embodiments in the mobile device may be stored in a recording medium. Here, a recording medium may be the storage 130 of FIG. 1, for example, or may be an additional separate recording medium. Here, the recording medium may include a storage medium such as a magnetic storage medium (e.g., a read only memory (ROM), a floppy disk, a hard disk, a magnetic tape, etc.) and an optical reading medium (e.g., a CR-ROM and a digital versatile disc (DVD)). The recording medium may be implemented as a carrier wave (e.g., transmission through Internet). Also, such above recording medium may be distributed over network coupled computer systems so that the computer readable code is stored and executed in a distributive manner.

In addition, the present inventive concept also includes a distribution server for providing a character input application operating in the mobile terminal via a network. Here, the character input application is obtained from at least one of the methods of controlling the mobile device described above.

For example, the character input application may be an application, in which the character arrangement window is displayed on an edge of the display area and when a touch has occurred on a portion of the display area, on which the character arrangement window is not displayed, such touch may be regarded as an event that a character corresponding to the touched portion, from among the characters included in the character arrangement window, is input. For example, the character input application may be an application, in which (i) character arrangement window is displayed on a first edge to a third edge of the display area that includes the first edge, the second edge adjacent to the first edge, the third edge facing the second edge and adjacent to the first edge, and a fourth edge facing the first edge, and (ii) when a touch has occurred in the display area, such touch is regarded as an event that a character corresponding to the touched portion, from among the characters included in the character arrangement window, is input.

The distribution server according to the one or more exemplary embodiments may include Google Play that is the official Android application market, a file providing server set by a manufacturer of the application file, or a file providing server for providing the application file.

While the inventive concept has been particularly shown and described with reference to exemplary embodiments thereof, it will be understood that various changes in form and details may be made therein without departing from the spirit and scope of the following claims.

### INDUSTRIAL APPLICABILITY

According to one or more exemplary embodiments of the inventive concept, a method of controlling a mobile device capable of improving user's convenience in input operation, a recording medium storing a program for executing the method, an application distribution server, and a mobile device may be implemented.

1. A method of controlling a mobile device, the method comprising:
displaying a character arrangement window on an edge of a display area; and
dividing the display area into a plurality of regions including regions corresponding to characters included in the character arrangement window and regions not corresponding to the characters, and when a touch has occurred on a region, on which the character arrangement window is not displayed and which corresponds to one of the characters included in the character arrangement window, regarding the touch as an event that a character corresponding to the region where the touch has occurred is input.

2. The method of claim 1, wherein the edge comprises a first edge, a second edge adjacent to the first edge, a third edge facing the second edge and adjacent to the first edge, and a fourth edge facing the first edge, and the displaying of the character arrangement window comprises displaying the character arrangement window on the first edge to the third edge of the display area.

3. The method of claim 2, wherein the displaying of the character arrangement window comprises displaying the character arrangement window on the first edge to the fourth edge.

4. The method of claim 2, wherein the character arrangement window is not displayed on a portion, except for the first edge to the fourth edge.

5. (canceled)

6. The method of claim 1, wherein the plurality of regions fill an entire portion of the display area.

7. The method of claim 1, wherein the plurality of regions comprise a portion on which the character arrangement window is displayed, and a portion adjacent to the portion where the character arrangement window is displayed.

8. The method of claim 1, wherein the plurality of regions fill a remaining portion of the display area, except the portion where the character arrangement window is displayed.

9. A method of controlling a mobile device, the method comprising:
displaying a character arrangement window on an edge of a display area;
when a touch has occurred on a portion of the display area, on which the character arrangement window is not displayed, regarding the touch as an event that a character corresponding to the touch is input, from among characters included in the character arrangement window; and
when a touch has occurred in at least a part that is set in advance in the portion where the character arrangement window is displayed, regarding the touch as an event that a specific function execution command that is set in advance is input.

10. The method of claim 1, wherein the displaying of the character arrangement window comprises displaying lines that divide the display area into the plurality of regions or dots corresponding to the plurality of regions on the display area.

11. A recording medium having embodied thereon a program for executing the method according to claim 1.

12. A distribution server for providing a character input application operating in a mobile device through a network, wherein the character input application displays character arrangement window on an edge of a display area; divides the display area into a plurality of regions including regions corresponding to characters included in the character arrangement window and regions not corresponding to the characters; and when a touch has occurred on a region, on which the character arrangement window is not displayed and which corresponds to one of the characters included in the character arrangement window, regards the touch as an event that a character corresponding to the region where the touch has occurred is input.

13. A mobile device comprising:
a display unit comprising a display area and provided with a touch screen function; and
a character determiner configured to determine a character corresponding to a touch according to a location where the touch has occurred, when the touch has occurred in the display area,
wherein the display unit displays character arrangement window on an edge of the display area, and the character determiner divides the display area into a plurality of regions including regions corresponding to characters included in the character arrangement window and regions not corresponding to the characters, and when a touch has occurred on a region, on which the character arrangement window is not displayed and which corresponds to one of the characters included in the character arrangement window, determines a character corresponding to the region where the touch has occurred is input, from among characters included in the character arrangement window.

14. The mobile device of claim 13, wherein the edge comprises a first edge, a second edge adjacent to the first edge, a third edge facing the second edge and adjacent to the first edge, and a fourth edge facing the first edge, and the display unit displays the character arrangement window on the first edge to the third edge of the display area.

15. The mobile device of claim 14, wherein the display unit displays the character arrangement window on the first edge to the fourth edge.

16. The mobile device of claim 14, wherein the display unit does not display the character arrangement window on a portion, except for the first edge to the fourth edge.

17. (canceled)

18. The mobile device of claim 13, wherein the plurality of regions fill an entire portion of the display area.

19. The mobile device of claim 13, wherein the plurality of regions comprise a portion on which the character arrangement window is displayed, and a portion adjacent to the portion where the character arrangement window is displayed.

20. The mobile device of claim 13, wherein the plurality of regions fill a remaining portion of the display area, except the portion where the character arrangement window is displayed.

21. A mobile device comprising:
a display unit comprising a display area and provided with a touch screen function; and
a character determiner configured to determine a character corresponding to a touch according to a location where the touch has occurred, when the touch has occurred in the display area,
wherein the display unit displays character arrangement window on an edge of the display area, when a touch has occurred on a region, on which the character arrangement window is not displayed, in the display area, the character determiner determines a character corresponding to the touch, from among characters included in the character arrangement window, and when a touch has occurred in at least a predetermined part of the portion on which the character arrangement window is displayed, the character determiner regards the touch as an event that a specific function execution command that is set in advance is input.

22. The mobile device of claim 13, wherein the display unit displays lines that divide the display area into the plurality of regions or dots corresponding to the plurality of regions on the display area.
